(19) United States
(12) Patent Application Publication
(10) Pub. No.: US 2006/0153435 A1
(43) Pub. Date: Jul. 13, 2006

(54) Method and means for 2d-gel-image segmentation

(76) Inventors: Gustav Wallmark, Lund (SE); Anders Heyden, Dalby (SE); Andreas Karlsson, Lund (SE); Ola Frosstrom-Olsson, Lund (SE)

Correspondence Address: LADAS & PARRY LLP, 224 SOUTH MICHIGAN AVENUE, SUITE 1600, CHICAGO, IL, 60604, US

(21) Appl. No.: 10/516,800

(22) PCT Filed: Jun. 19, 2003
(86) PCT No.: PCT/SE03/01060

§ 371 Date: Dec. 6, 2004

(30) Foreign Application Priority Data
Jun. 19, 2002 (SE) 0201894-3

(51) Int. Cl. G06E 3/00

(52) U.S. Cl. 382/129

(57) ABSTRACT

The present invention relates to the segmentation of two-dimensional gel electrophoresis images (2D images). The method according to the invention associates an initial protein seed candidate with an interface circumscribing said seed and thereafter brings said interface to evolve in accordance with a defined speed function F(x, y). The evolution of the interface is halted by a stopping criterion, C. According to the invention, the speed function can depend on a wide variety of parameters such as the pixel intensity, the curvature of the pixel intensity, the distance to the initial seed, the curvature and/or shape and/or normal direction and/or position of the evolving interface. The stopping criterion depends e.g. on the speed function F and/or the time of arrival T(x, y) and/or the departure time T_{d} for said interface. The invention provides criteria for a specific treatment of saturated spots and to mike sure that interfaces never overlap.

### TECHNICAL FIELD OF THE INVENTION

The present invention relates generally to the field of proteomics and more specifically to a method and means providing efficient segmentation of two-dimensional gel electrophoresis images (2D gel images) allowing a more efficient and accurate protein identification.

### STATE OF THE ART

The field of proteomics has gained importance over the last ten years. 2D gel images have been used in a diverse range of applications, where separation of proteins is essential. In particular, the 2D gel importance in proteomics has grown and still today it is unparalleled in its ability to separate and array complex proteins. Before the 2D gel separation technique can be applied, a protein sample has to be extracted from the examined media containing proteins. The sample has to be pure and free of other contaminating substances, otherwise the separation will be disturbed or even fail. There exists numerous techniques to purify the proteins and today this is not problematic. After receiving the protein sample, it is placed on a so called strip. The strip is typically made of polyacrylamide gel, contains a pH gradient and is about 10 cm long and 1 cm wide. Because of the pH gradient, the proteins will separate according to their isoelectric points over a period of about ten hours. When this is done the strip and the one-dimensional separated proteins are transferred to a second dimension, according to their molecular weights. The transformation is done by placing the strip on the side of a plate consisting of sodium dodecyl sulfate-polyacrylamide gel. An electric field is applied over the plate and the strip, forcing the proteins to merge into the plate at different speeds depending on their molecular weight. In this way the proteins are separated in two dimensions, i.e. in a pH-isoelectric- and a molecular weight dimension. The 2D gel separation process can be done with many different types of gels and staining techniques, known to a person skilled in the art, and the above procedure is just one of them.

An example of the result from a 2D gel separation is illustrated by the 2D gel image in FIG. 1. A 2D gel image can typically contain about 1000-6000 detectable protein spots. In a 2D gel image each spot typically represent the presence of (a certain amount of) a specific protein. As can be understood by viewing FIG. 1, it can be a hard and time consuming task for the human eye to identify the different protein spots. Therefore, computer assisted image processing and analysis has become an important tool when evaluating 2D gel images. Many different 2D gel image processing techniques based one e.g. mathematical morphology, parametric spot models and Gaussian scale space blob detector.

Ideally, all spots containing proteins in the 2D gel image should be segmented while no false segments, i.e. segments not containing proteins, should be obtained. The segmentation should also have a high resolution allowing the distinction of different protein spots in a close neighbourhood. The segments should ideally circumscribe the whole area in which a certain type of protein is present while not including any area lacking said protein. Problems regarding known segmentation techniques concern their incapability to identify all protein spots, to distinguish real spots from background and their shortcomings to identify different types of proteins when these are not very separated in the image. Another problem with the existing segmentation techniques relates to over segmentation, i.e. a region originating from a single type of protein is erroneously segmented into a plurality of regions. A further problem with state of the art 2D gel image segmentation techniques is that the resulting segments are larger or smaller than they should be. This makes the followed analysis and calculation regarding the amount of proteins, typically the volume of the spots, contained in the analyzed protein sample less reliable and accurate. Thus, the resulting segments must not be too large nor too small but shall correspond to the real protein distribution in order to make the following analysis as accurate as possible. Still another problem with the state of the art 2D gel image segmentation techniques is that they are not very flexible to adapt to different types of protein shapes expressed in various 2D gel images. For instance, protein separation of blood serum gives very different protein spot shapes in the 2D gel image, compared to the spot shapes obtained from liver cells.

### SUMMARY OF THE INVENTION

The object of the present invention is to solve or alleviate above problems by providing an efficient segmentation of 2D gel images facilitating further analysis of the image and making the final interpretation result more accurate.

One object of the image segmentation according to the invention is to find and identify as many protein spot candidates as possible in a 2D gel image and facilitate the judgement regarding their genuiness.

According to one aspect, the present invention achieves above objects by providing a 2D gel image segmentation method by associating initial protein seed candidates with surrounding regions wherein an interface is defined to circumscribes an initial seed and thereafter bringing said interface to evolve in accordance with a defined speed function F(x, y), and letting a stopping criterion, C, halt said evolution. The area lying inside said halted interface is thereafter associated with said initial seed.

According to another aspect, the present invention achieves above objects by providing a computer program element to be used for the segmentation of a 2D gel image by associating initial protein seed candidates with surrounding regions. According to this aspect, said program element comprises computer program code means which make a computer define at least one interface so that it circumscribes an initial seed and thereafter bringing said interface to evolve in accordance with a defined speed function F(x, y), and letting a stopping criterion, C, halt said evolution. The area lying inside said halted interface is thereafter associated with said initial seed.

According to a third aspect, the present invention achieves above objects by providing a computer readable medium to be used for the segmentation of a 2D gel image by associating initial protein seed candidates with surrounding regions. According to this aspect, said medium comprises computer program code means which make a computer define at least one interface so that it circumscribes an initial seed and thereafter bringing said interface to evolve in accordance with a defined speed function F(x, y), and letting a stopping criterion, C, halt said evolution. The area lying inside said halted interface is thereafter associated with said initial seed

According to a fourth aspect, the present invention achieves above objects by providing a system comprising a computer to be used for the segmentation of a 2D gel image by associating initial protein seed candidates with surrounding regions. According to this aspect, said system comprises a computer having access to program code means instructing said computer to define at least one interface so that it circumscribes an initial seed and thereafter bringing said interface to evolve in accordance with a defined speed function F(x, y), and letting a stopping criterion, C, halt said evolution. The area lying inside said halted interface is thereafter associated with said initial seed.

Although the present invention has been summarised above, the present invention is defined by the independent claims 1, 19, 20 and 21.

Further embodiments of the invention are defined by the dependent claims 2-18.

### SHORT DESCRIPTION OF THE DRAWINGS

FIG. 1 shows a typical 2D gel image.

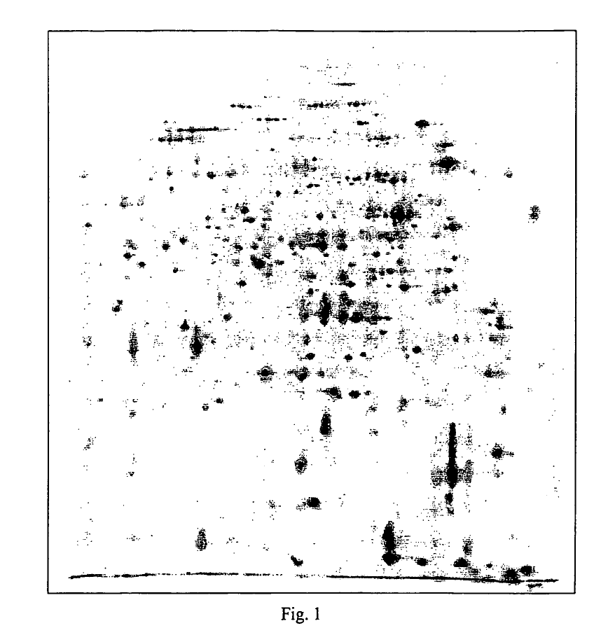

FIG. 2 shows a schematic block diagram of the segmentation system according to the present invention.

FIG. 3 shows a part of a 2D gel image with its corresponding initial seeds.

FIG. 4 shows a part of a 2D gel image and its three-dimensional representation.

FIG. 5 shows an example of the solution to the Eikonal equation given in Eqn (1).

FIGS. 6a-f illustrate an example of the boundary value formulation solved with the Fast Marching Method wherein each image represents a stage in the interface evolution.

FIG. 7 shows an orthogonal mesh with five grid points.

FIG. 8 shows a min heap with six elements and its equivalent array representation.

FIG. 9 illustrates an example of a segmentation result.

FIG. 10 illustrates another representation of the segmentation result of FIG. 9.

FIG. 11 shows a protein spot in one and two dimensions.

FIG. 12 shows the gradient of a protein spot in both one and two dimensions.

FIG. 13 shows a schematic view of the creation of I_{S}(x, y) and G_{S}(x, y) according to the present invention.

FIG. 14 shows an example of the resulting speed function F(x, y) according to the present invention obtained for a protein spot in both one and two dimensions.

FIG. 15 illustrates a comparative example of a genuine and a false spot regarding a speed function according to the present invention.

FIG. 16 illustrates two stopping criteria examples according to the invention.

### DEFINITIONS

The following terminology is used in this document:

Protein Spot: an intensity valley present in the 2D Gel image visible as a dark spot. Each protein spot consists of the intensity reading obtained during the scanning of the 2D gel from one type of the stained diffused protein type, forming a cluster of many millions of similar protein molecules.

Spot: carries the same definition as the term “protein spot” above.

Initial Seed: a marker indicating that there is a protein spot present on its location in the 2D gel image. It is used as an initial boundary for the evolving interface propagation.

Initial Seed Region: a region in the 2D gel image, which contains one initial seed. The region typically fully covers a protein spot in the 2D gel image after the evolving interface stage has been performed.

Tₐ(x, y): the time of arrival for the evolving interface at pixel (x, y)

T_{d}: the departure time for the evolving interface at pixel (x, y)

P_{Tmin}: the candidate pixel with the smallest time of arrival T_{A}.

P_{Td}: the candidate pixel with the smallest departure time T_{d}.

### DETAILED DESCRIPTION OF PREFERRED EMBODIMENTS

Overview

The present invention shall now be described with reference to the accompanying figures. The method according to the invention is typically carried out by a software program running on a computer.

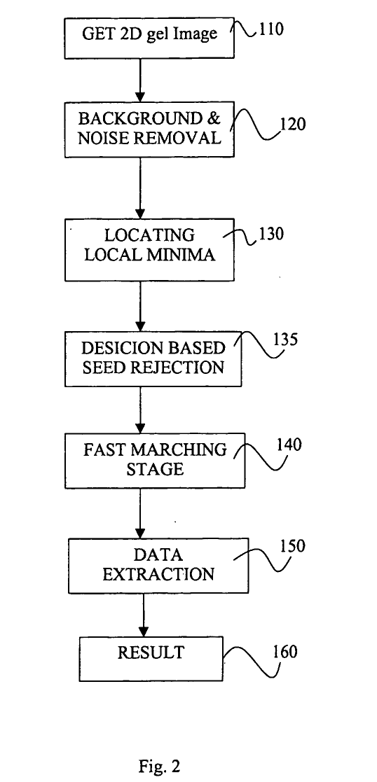

FIG. 2 illustrates a schematic block diagram for the image processing and segmentation method according to the present invention. The 2D gel image is obtained in a digital format, e.g. in a TIF-format, by conventional scanning, in step 110. Thus, the image is represented as a pixel intensity matrix I(x,y), where I is the grey scale intensity in a given pixel position (x,y). Dark areas, as illustrated herein, have lower intensity values than lighter areas. Since the 2D gel image is represented as a numerical matrix, each pixel will have 8 “close neighbour”-pixels, except for the edge pixels, which will have 5 “close-neighbour”-pixels, and the corner pixels, which will have 3 “close neighbours”.

The image is then subject for pre-processing in step 120 in order to enhance the image quality. This typically means cleaning the image from noise and background variations, as described in detail below.

The method according to the invention then continues to step 130 in which a first initial seed selection is carried out, where said selection represent a good initial guess regarding protein spot positions. This means as many spots as possible in the 2D gel image each have a corresponding initial seed. The association is based on specific mathematical image criteria as explained in detail below. The method according to the invention thereafter continues to step 135 wherein said initial guess is further processed with the object to filter out initial seeds which do not correspond to protein spots, but instead deviations such as presence of noise or “spot like” patterns. Step 135 is described in detail below.

Thereafter, the inventive method continues to step 140 wherein an evolving interface stage is performed. This is where the image is segmented and protein spots are associated with an initial seed region. Each initial seed region is given an integer number and the background is represented with 0. Thus, the highest integer an initial seed region has represents the total number of protein types found in the image. Segmenting 2D gel images means extracting as many real protein spots as possible from the protein pattern in the 2D gel image.

Followed by this step is step 150, wherein information about each initial seed region is collected, with the help of mathematical methods. This information typically comprises, for each initial seed region domain, e.g. the centre of mass, the minimum pixel intensity, the spread in the x- and y direction, the area, the volume, the curvature and the statistical similarity of the protein spot inside the initial seed domain in comparison with a “typical” protein spot domain etc.

Thereafter the present invention further continues to the final step 160, where the processing result is presented to the end user or stored in a data file on a, e.g. portable disk, data base, compact disk or other media with data storing capability.

Steps 150 and 160 represent state of the art and will not be further discussed here.

The present invention makes use of the intensity function I(x,y) of the 2D gel image, as explained above, the 2D gel image gradient G(x, y) of I(x,y) and the Laplacian L(x,y) of I(x, y). The gradient and the Laplacian of a digital image can be estimated in many different ways known to a person skilled in the art and will not be further discussed here.

The present invention relates principally to step 140 in FIG. 2, but for reasons of clarity the software algorithms realising steps 120, 130, 135 and 140 in FIG. 2 shall now be described in detail.

Pre-Processing

Step 120, in FIG. 2, will now be described in detail. When the background is removed, i.e. the bias in the image, the optimal result would be:

1. Non-existing background or

2. Homogenous background with significantly different properties than the protein spots.

3. Controlled or no changes to the protein spot pattern visible in the images.

A simple and surprisingly well functioning background removal, based on bilinear interpolation, can be used in step 120 to carry out the invention. The idea is based on the assumption that the background varies with low frequencies and does not have large discontinuities. This makes it possible to build a module of the background using bilinear surface blocks. To build the blocks, a bilinear interpolation method can be used. The following algorithm to modulate and subtract the background can be used according to the invention:

1. Decide block size: The size of the building blocks is based on how much the background varies in the image or simply a user input.

2. Decide gird size: This is the distance between the blocks, which in some sense gives the resolution of the image. This quantity is also dependent on background variations or user input.

3. Position grid points according to the decided grid size: At the image corners and the fringes the grid points are positioned so that the all grid points form a whole number of image parts in both x- and y-direction when they act as corners to the modulated image blocks.

4. Calculate mean intensity in each grid point: Based on the block size a part of the 2D gel image is extracted and its mean intensity is calculated and stored in the grid point.

5. Take the grid points to be corners of the modulated blocks

6. Create modulated blocks with bilinear interpolation between the corners of each block

7. Put the modulated blocks in a background image

8. Subtract original image with background image and invert the result.

Above algorithm is an illustrative example of how to remove low frequency bias in an image and the invention is not restricted to this example. For instance, “morphological methods” can be used. This means, among other things, that “mean value” in above step 4 is changed to “max value” and a new image is created. This new image is thereafter processed again according to the same principle but this time the “mean value” in above step 4 is changed to “min value”. In this way, changes with a spread smaller than the “Block size” are cancelled out. “Block size” can also be arranged as a circle depending on the characteristics of the unwanted interference.

Noise in the images is always present in varying amount and is suppressed in step 120, according to one embodiment of the present invention. The reason to remove noise in the images is to facilitate the initial seed selection in the following step 130 and 135. Noise can be removed in the images in step 120 by using a mean- or a Gaussian filter or a combination of both, as known to a person skilled in the art. The two filters can be convoluted with each other in order to speed up the algorithm, as known. The filter size is typically determined by frequency analysis, as known to a person skilled in the art. Many different noise removal approaches exits, such as “median filter” and “adaptive smoothing”, and is known by a person skilled in the art, and above noise removal proposal act only as illustrative examples and does not restrict the invention.

Initial Seeds Selection

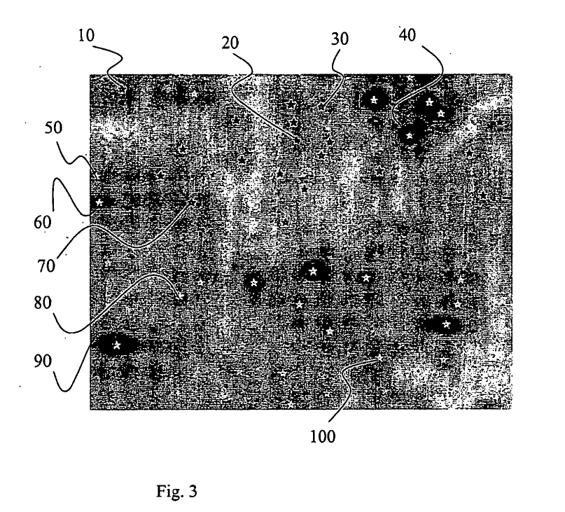

One of the main issues of the segmentation system according to the present invention is to find good initial seeds in steps 130 and 135. The initial seeds form a base for the evolving interface stage in the followed step 140. Each protein spot in the image should be marked with an initial seed. If a protein spot is not marked with a seed it will not be regarded as a protein spot. Instead it will be part of the background in the image. In FIG. 3, some protein spots, 10, 20, 30, 40, 40, 50, 60, 70, 80 and 90 with corresponding initial seeds are shown.

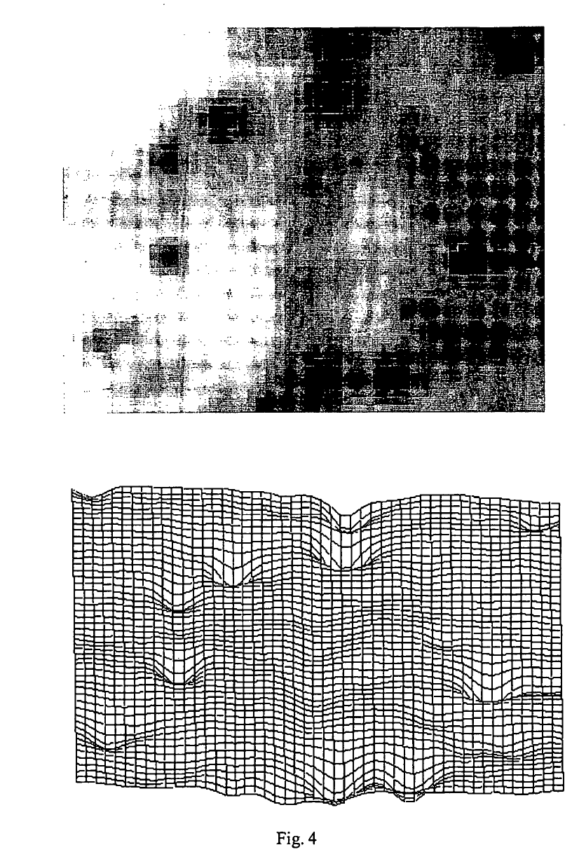

In 2D gel images the protein spots are represented by varying shapes and sizes of grey level valleys, see FIG. 4. This protein spot property is used to find initial seeds that will mark each protein. According to the invention, a good starting guess is made in step 130 by identifying all local minima in the image and marking them as initial seeds, i.e. associate them with the presence of proteins.

Different techniques can be used to locate local minima, according to the invention. One way to locate local minima in images is to look at the gradient and the Laplacian of the pixel intensity function I(x, y) of the image. A local minimum is defined so that the gradient has a zero crossing and the Laplacian is negative. Here the sign of the Laplacian depends on the definition of the Laplacian, known to a person skilled in the art. This approach works well in theory, but not so well in practice. In the discrete images which contain protein spot valleys, the gradient might never become zero. Also, the Laplacian might not be negative at the lowest value in the valley. Instead, a more efficient method to identify local minima is based on a simple pixel intensity comparison. A local minimum is defined as a pixel with the intensity value, I, whose eight-connected neighbour pixels all have a value greater than or equal to I. In rare cases a local minimum region might get two or more markers. This indicates that there are two or more spots lying very close to each other. This happens when a ridge with higher values pushes up in the middle of the region. This is a desirable feature which increases the chances of protein detection, as understood by a person skilled in the art. FIG. 4 illustrates a 2D gel image with protein spots and its three-dimensional representation.

The following algorithm describes the identification of local minima in step 130 in FIG. 2.

1. Get centre pixel and its eight-connected neighbours: The fringe of the image is neglected.

2. For each neighbour look at its value: The lowest neighbour value is stored in a variable.

3. Neighbour has higher or equal value: If neighbour is marked as local minimum unmark it.

4. All neighbours have higher or equal values: Mark centre pixel as local minimum.

5. Loop: While not end of image, go to Stage 1. (Walk through the image from right to left and top to bottom.)

If a whole region is a local minimum, then the region will be given one or more seeds according to the invention, as stated above. This happens when one or several spots are saturated in the 2D gel image. These regions can be identified e.g. by defining a saturation level threshold and identify regions wherein multiple neighbouring pixels has an intensity level below said threshold. Other known robust methods can be used to find saturated spots.

The present invention makes use of the following three properties to distinguish correct initial seeds from false initial seeds:

1. Local Minimum of the pixel intensity.

2. Curvature characteristics of the pixel intensity in the region surrounding the initial seeds.

3. The intensity I.

Regarding the found local minima in step 130, it often occurs that the local minima are situated in a background deviation, such as noise. To avoid treating these local minima as protein spots and using them as initial seeds, the present invention uses a decision based rejection. This decision based rejection is carried out in step 135, in FIG. 2. A good way to find out if a local minimum is situated in a protein spot or a deviation is to look at the curvature in the local minimum surrounding. The mathematical theory for finding a value of the curvature in an image is well known. The curvature can for instance be calculated by finding the Laplacian of pixel intensity of the image. A convex curvature is represented, depending on the definition of the Laplacian, with values below zero and vice versa for the concave curvature. Thus, a protein spot which has convex shape in its local minimum surrounding, has negative values in its local minimum surrounding. By defining the size of the surrounding and the amount of concaveness the protein spot has to show, a more robust initial seed identification can be achieved. This seed rejection is carried out in step 135 in FIG. 2.

In some protein spots, it can occur that the spot is saturated, which yields that the bottom of the spot is “cut off”, i.e. the spot has a bottom with a central region of pixels having substantially the same minimum pixel intensity. By introducing a third criterion for the seed identifications in step 135, these kinds of protein spots can also be identified, despite their non-concaveness, as described above.

The described method above is an example of how initial seeds in 2D gel images can be located and, as known for a person skilled in the art, there exists numerous other methods. Therefore, the invention is not restricted to this example.

Evolving Interface

When the initial seeds that represent each protein spot have been located in step 135, the evolving interface stage is started in step 140. This is according to the invention accomplished by first assigning each initial seed as an initial interface and then allowing said interface to evolve in accordance with a speed function F(x, y) derived from a differential equation for the interface.

In one embodiment according to the invention, F(x, y) is allowed to assume only positive values, i.e. the evolving interface can only expand.

In another embodiment, F(x, y) is allowed to assume both positive and negative values, i.e. the evolving interface can expand and shrink.

Thus, the invention gives two main options to formulate the differential equation for the interface propagation. The first option is to let the speed function F(x,y) always have values greater than zero. Then, the positions of the propagating front can be monitored by calculating its arrival time Tₐ(x, y) at the position (x, y). The equation for the time function is easily found, because distance=rate×time, which gives the Eikonal differential equation:
|∇T|F=1, T=0 on Γ
where Γ is the initial location of the interface.

Now, the interface motion can be described as the solution to a boundary value problem. If the speed function F(x, y) depends on the position of the front, the differential equation will become a non-linear Eikonal equation.

The second option to formulate the differential equation according to the invention does not demand that the speed function F is strictly positive, as stated above. It is a more general formulation which allows the front to move past the same position (x, y) several times, i.e. to both expand and shrink. When F(x,y) is negative, the front can move backwards and revisit an already passed position. Hence, the crossing time function T(x, y) is a multi-valued function. To describe the motion of the front, a higher-dimensional function φ with the fronts initial starting point as the zero-level set, must be introduced. This leads to a differential equation with the initial value formulation:
φ+F|∇φ|=0, given φ(x,t=0)

In one embodiment according to the invention, above differential equation (1) or (2) is numerically solved by means of applying the Fast Marching method, which is a known mathematical method for the analysis of moving interfaces.

In another embodiment according to the invention, above differential (2) is numerically solved by means of applying the Level Set method, which is a known mathematical method for the analysis of moving interfaces.

Returning to the boundary value formulation again, recall that the interface evolution will be known when the Eikonal equation has been found. One problem in solving these equations is that the solution does not have to be differentiable, even with smooth initial boundaries.

The Fast Marching Method is a computational technique, which approximates the solutions to the non-linear Eikonal equation, i.e. the boundary value formulation, as stated above. The method also deals with non-differential solutions in a natural way, which otherwise could cause problems.

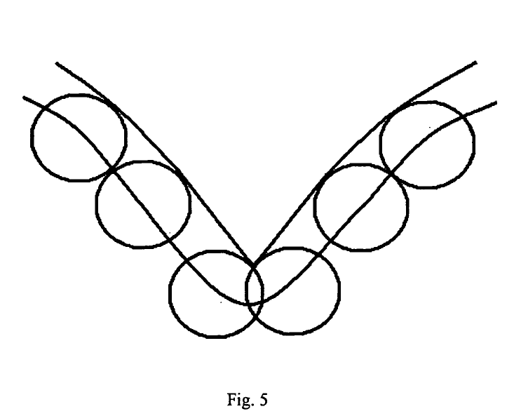

To further investigate the solutions that might be non-differentiable, consider an example of a non-convex initial curve and its differential equation given by:
|∇T|=1
The speed function F(x, y) is in this case constant and equal to one (F(x,y)=1). Suppose it is interesting to know where the interface is positioned after one unit in time. In FIG. 5, the initial curve and its propagation in question are shown. The above result shows that it is possible to end up with a non-differentiable solution even with a smooth initial boundary. This implies that the approximation schemes used for the Eikonal equation must be able to deal with non differentiable solutions.

The Fast Marching method will here be described briefly, in order to fully understand how the present invention can be carried out. The Level Set method is a similar approach and both methods are described e.g. in the article “A Fast Approximation of Level Set-like Active Contours”, by Björn Nilsson and Anders Heyden, published in Pattern Recognition Letters no 24, 2003, pp 1331-1337, hereby incorporated by reference and referred to as “Nilsson and Heyden”.

In the Fast Marching Method, an approximation of the gradient using upwind differences is used. The upwind scheme is based on Euler's method for approximating the derivatives. By solving the ordinary differential equations outwards along the positive and negative x-axis, in the one dimensional case, the approximation is given by:

$$\frac{( {T}_{i + 1} - {T}_{i} )}{Δ x} = {F}_{i} i > 0$$

$$\frac{( {T}_{i + 1} - {T}_{i} )}{Δ x} = - {F}_{i} i \leq 0$$

where T₀=0. Hence, each ordinary differential equation is solved away from the boundary condition. It is possible to approximate the Eikonal equation with an equation of motion given by
ψₜ=S(1+ψₓ²)^{1/2}
in the one-dimensional case, where S is the speed function, The spatial derivative ψₓ² can be approximated with a finite difference approximation built on the upwind scheme, as known. This approximation yields
ψₓ²≈(max(Dᵢ^{+x}ψ,0)²+min(Dᵢ^{-x}ψ,0)²)
where the standard notation for the finite difference given by

$${D}_{i}^{- x} ψ = \frac{{ψ}_{i} - {ψ}_{i - 1}}{h}$$

$${D}_{i}^{+ x} ψ = \frac{{ψ}_{i + 1} - {ψ}_{i}}{h}$$

has been used. Above, ψᵢ is the value of ψ on a grid at the point ih with grid spacing h.

Now, the Eikonal equation can be written, in the two-dimensional case, as:

$$\vert ∇ T \vert \approx {( \begin{matrix}{max ( {D}_{ij}^{- x} T , 0 )}^{2} + {min ( {D}_{ij}^{+ x} T , 0 )}^{2} + \\ {max ( {D}_{ij}^{- y} T , 0 )}^{2} + {min ( {D}_{ij}^{+ y} T , 0 )}^{2}\end{matrix} )}^{1 / 2} = \frac{1}{{F}_{ij}}$$

where the forward and backward operators D^{-y} and D^{+y} are similar to the ones defined for the x-direction in the above finite differentiation. A slightly different and more convenient approximation, is given by:

$$\vert ∇ T \vert \approx {( \begin{matrix}{max ( {D}_{ij}^{- x} T , - {D}_{ij}^{+ x} T , 0 )}^{2} + \\ {max ( {D}_{ij}^{- y} T , - {D}_{ij}^{+ y} T , 0 )}^{2}\end{matrix} )}^{1 / 2} = \frac{1}{{F}_{ij}}$$

This equation is a piecewise quadratic equation for Tᵢⱼ, i.e. Tₐ in position (i, j), given that the neighbouring grid values for Tₐ are known. With this approximation the non-differentiability in the Eikonal Equation is dealt with in a natural way and it will not cause any trouble. The above approximations lead to information propagating from smaller values of Tₐ to larger values. Hence, the Fast Marching Method rests on solving the above equation 1 by building the solution outwards from the smallest value of Tₐ.

By defining the building zone to a narrow band around the front it is possible to make the Fast Marching Method very fast, because it does not have to keep track of every value in the solution at the same time. The key to the speed lies in how to update the narrow band and how to select which grid point in the narrow band to update. Selecting the grid point to update is straight forward. The grid point with the lowest calculated Tₐ is the one to update. Thus, the Fast Marching Method can be summarised in the two-dimensional case, i.e. the case relevant for the invention, by the following algorithm:

1. Initialize given boundary: Tag all grid points in the initial condition as Known. Continue by marking as Trial all unknown four-connected neighbours to the Known points. Finally, tag all other grid points as Far.

2. Get next candidate point: Let the next candidate grid point be the one in Trial with the smallest value of Tₐ. This point is denoted P_{Tmin}.

3. Update narrow band: Remove the candidate point from the set Trial and tag it as Known. Tag also all unknown four-connected neighbours of the candidate point as Trial. If a neighbour is of type Far, add it to the narrow band by removing it from the Far list and adding it to the set Trial.

4. Recompute Tₐ values: Recompute the Tₐ values for all four-connected values of the candidate point in stage 2 by solving above Eikonal equation.

5. Loop: While stopping criteria are not reached, go to stage 2.

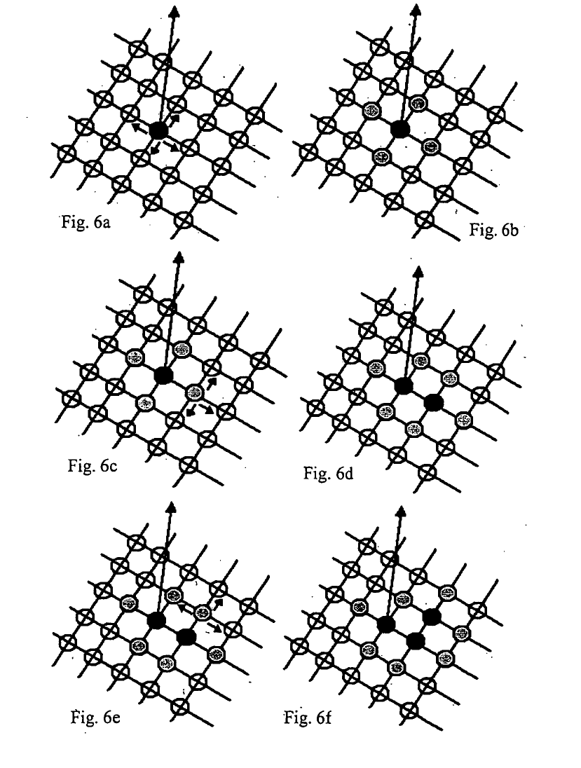

FIG. 6 gives an illustrative example of the Fast Marching Method according to the above algorithm. In FIG. 6, the centre grid point is the initial boundary, black grid=Known, grey grid=Trial and transparent grid=Far. The example is a boundary value formulation with known boundary value at the centre grid point. Black grid points represent Known grids, grey Trial grids and transparent Far grids.

As can be seen in FIG. 6, each image represents a stage in the interface evolution

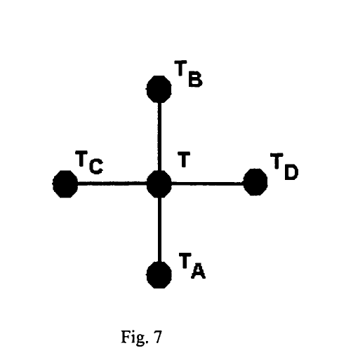

A very important and central role in the Fast Marching Method is the updating procedure for Tₐ values. This is the procedure by which new trial values are created for Tₐ in the narrow band. By solving above Eikonal equation a new value of Tₐ is obtained. By solving the Eikonal equation means solving a piecewise quadratic equation for Tᵢⱼ, i.e. Tₐ in pixel (i, j), assuming that the neighbouring grid values for Tₐ are given. In the special case with an orthogonal mesh, an algebraic solution to the Eikonal equation can be found. In the following example this will be shown. Thus, imagine that an orthogonal mesh exists, like the one in FIG. 7, which illustrates an orthogonal mesh with five grid points. Suppose that the goal with the updating procedure is to calculate a new value for Tₐ in FIG. 7 at the centre grid point. The surrounding values of Tₐ in FIG. 7 are labelled according to T=T_{a(x,y)}, T_{A}=T_{a(x-1,y)}, T_{B}=T_{a(x+1,y)}, T_{C}=T_{a(x;y-1)} and T_{D}=T_{a(x,y+1)}. Standing at the centre point T in FIG. 7, the Fast Marching Method attempts to solve the quadratic equation given by each quadrant. In this example only T_{A}, T_{B} and T_{c} act as contributors since the grid point T_{D} is regarded as a Far value and does not have any influence on the solution. Thus, there are three cases to look at when solving the equation and they are the following:

If only T_{A} is known then the real solution with the smallest Tₐ so that Tₐ>T_{A} is given by either:
(T−T_{A})²=1/(F_{xy})²
or
(T−T_{A})²+(T−T_{B})²=1/(F_{xy})²
or
(T−T_{A})²+(T−T_{C})²=1/(F_{xy})²
or
(T−T_{A})²+(T−T_{B})²+(T−T_{C})²=1/(F_{xy})²
If T_{A} and T_{B} are known then the real solution with the smallest Tₐ so that Tₐ>T_{A} and Tₐ>T_{B} is given by either:
(T−T_{A})²+(T−T_{B})²=1/(F_{xy})²
or
(T−T_{A})²+(T−T_{B})²+(T−T_{C})²=1/(F_{xy})²
If T_{A}, T_{B} and T_{C} are known then the real solution with the smallest Tₐ so that Tₐ>T_{A}, Tₐ>T_{B} and Tₐ>T_{C} is given by:
(T−T_{A})²+(T−T_{B})²+(T−T_{C})²=1/(F_{xy})²

It is easily seen that the number of equations to be solved (M), related to the number of neighbouring grid points with Trial values for T (n) is M=2 n

To keep the Fast Marching Method fast, a god sorting technique must be used. The reason for this is that after every narrow band update, all Trial values in the narrow band have to be resorted. This is the guarantee that the smallest value of Tₐ will be the next candidate. A heap sorting method is a very good method choice to keep track of the Trial values. Heap sort is an optimal way of sorting information. It does not require any extra space and has a time complexity of O(nlog(n)), which is very fast. The sorting technique is based on heaps. A heap is a tree where every node has a key more extreme (greater or less) than the key of its parent. The tree must be a complete tree, which means that

1. it is empty or

2. its left subtree is complete of height h-1 and its right sub-tree is completely fill of height h-2 or

3. its left subtree is completely full of height h-1 and its right sub-tree is complete of height h-1.

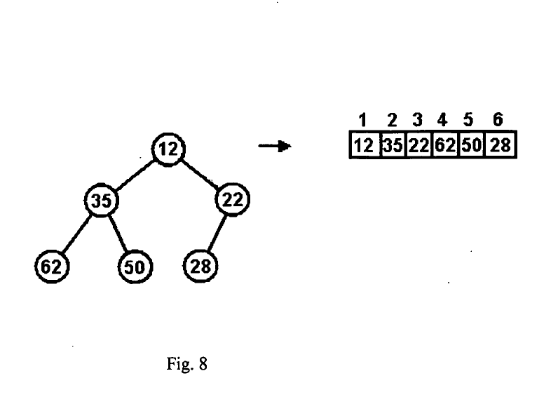

A binary tree is typically represented by a vector. This is a very efficient way of implementing a heap. The vector representation does not require any extra space if the tree is complete. By numbering the nodes from top to bottom and left to right, the children of node i are at 2i and at 2i+1 if they exist, and the parent of node i is at [i/2] (integer part of the division) if it exists. FIG. 8 shows a min heap with six elements and its equivalent heap vector array.

To use the heap sorting algorithm in the Fast Marching Method certain operations on the heap must be supported. These are:

1. Remove smallest value of T in the heap.

2. Add an element to the heap.

3. Update a key value at any given position in the heap.

These operations should be possible to complete while guaranteeing that the heap remains proper. It is also possible to extend the heap property to handle equal key values. The order of the equal key values is not guaranteed, but this is irrelevant for the present invention.

Thus, in step 140 in FIG. 2, an evolving interface is created around each initial seed. After the region growing process is done, each seed will have a defined expanded region surrounding the seed and this region will be associated with a specific protein. The expanded region is created by the evolution of interfaces wherein each initial seed is associated with an expanding interface, which starts in the seed itself and expands according to the invention. At some stages, said interface is also allowed to shrink according to some embodiments of the invention.

According to the invention, each interface expansion is based on at least one speed function F(x, y). The initial seeds have great impact on the result, but they have already been identified and are assumed correct, at this stage. As already stated, each initial seed is assigned an integer number which remains unchanged during the whole segmentation process. If there should exist false initial seeds during this step they will easily be detected after the interface expansion in this step since their interfaces will not be expanded very much while the interfaces of “valid” initial seeds will be expanded very fast out to the protein spot border region, where the expansion will stop. By marking the so expanded interfaces with a contour line it becomes an easy task to distinguish real spots from false. False spots will practically not be expanded at all.

The interfaces originating from two different seeds are not allowed to overlap, according to the invention.

As known, an automatic analysis is typically based on, e.g., but not limiting to, calculating the area and the volume inside the expanded area, i.e. the initial seed region. Thus, by applying the present invention, false initial seed regions, i.e. regions without a protein spot, will get a significantly less area and lower volume than the valid initial seed regions, i.e. regions containing protein spots, providing an efficient way to distinguish valid initial seed regions from false.

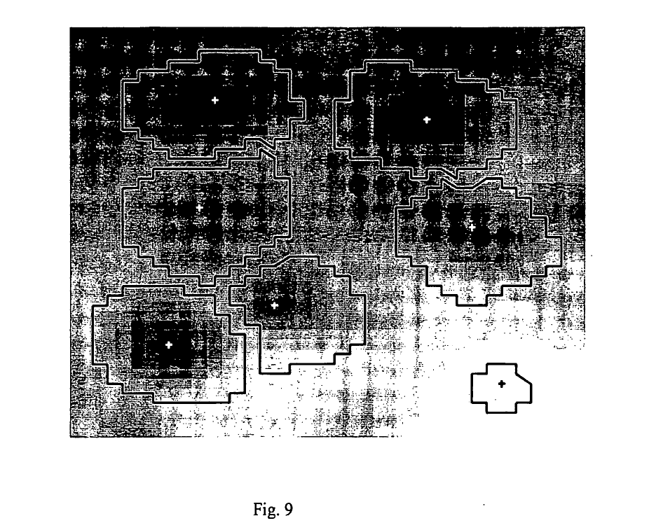

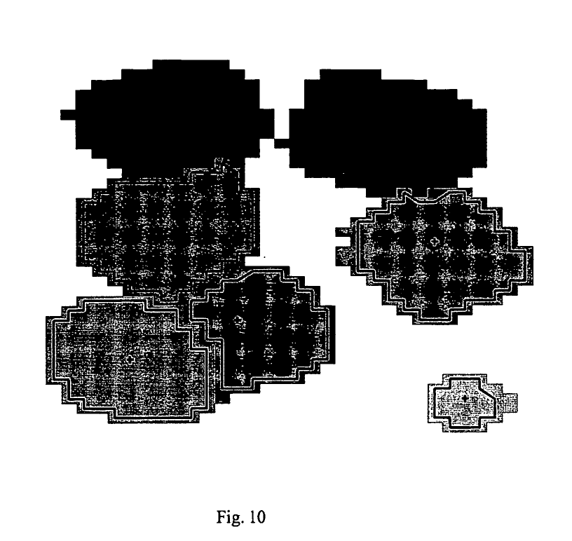

In FIG. 9, a segmentation result example is shown. The 2D gel image in FIG. 9, has six valid initial seed regions and one false initial seed region. The domain for each initial seed region is shown in FIG. 10. Non-initial seed regions are represented by white and the initial seed regions are represented by different grey colours. In both FIGS. 9 and 10 the initial seeds are marked with either a black or a white cross and the resulting contour by a black line.

The invention defines a solid speed function and a stopping criterion that will halt the segmentation, i.e. the expansion of the interfaces, in accordance with the Fast Marching Method. The speed function and the stopping criteria are chosen so that they, when used together, give segments, i.e. the initial seed regions, which can be further analysed faster and/or more accurately.

The speed function for expanding the interfaces in accordance with the Fast Marching Method is according to the present invention defined so it fulfils the following properties:

1. High values, i.e. giving a high speed, inside protein spots.

2. Low or zero values elsewhere.

The reason to create a speed function with these properties is to be able to get good stopping criteria for the interface propagation.

To define a good speed function, the nature of the protein spots is used, according to the invention. This means that the invention provides a possibility to adapt the speed function according to known specific characteristics for different protein spot shapes.

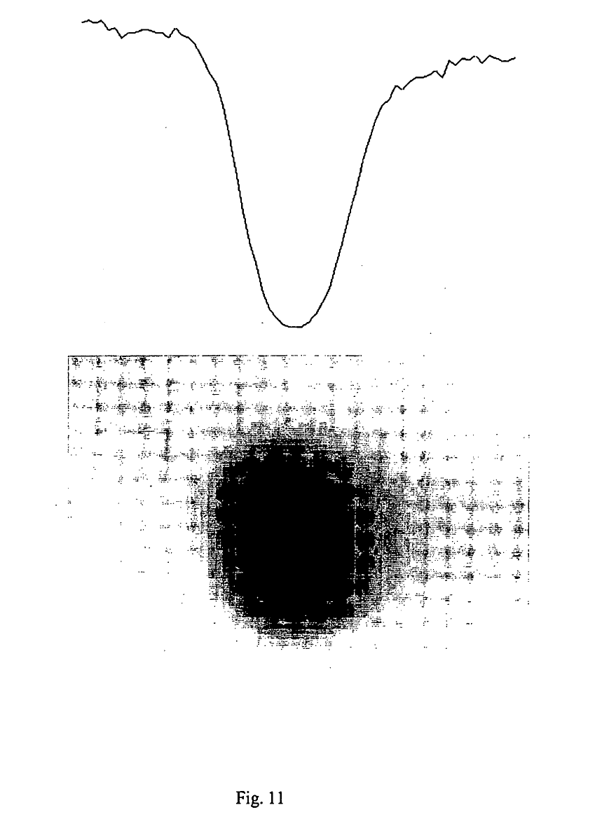

FIG. 11 shows a protein spot in both one and two dimensions. In FIG. 11, K denotes Known values. T denotes Trial Values. Non-marked denotes Far values. As can be seen from FIG. 11 the protein spot is represented by an intensity valley.

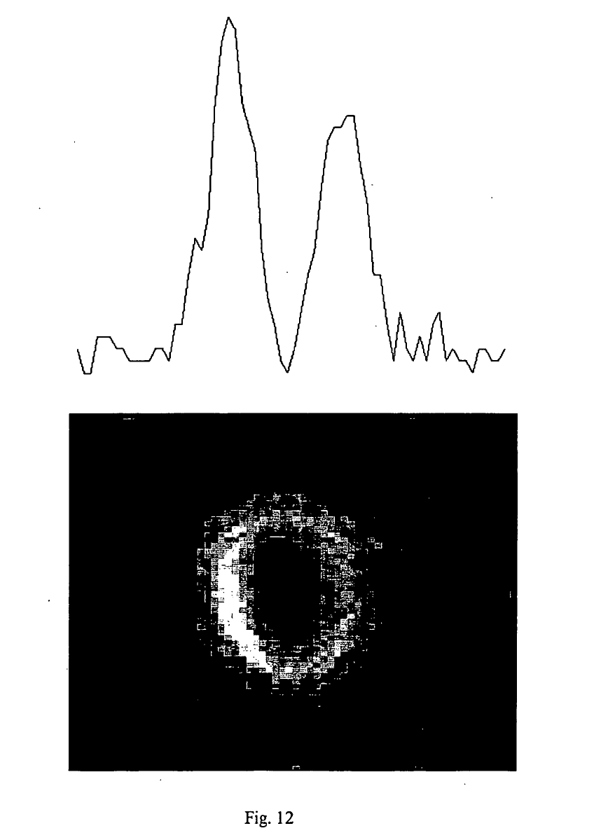

FIG. 12 shows the gradient of the protein spot in FIG. 11.

The present invention uses the intensity function I(x, y) and/or functions thereof in order to obtain a speed function with the above desired properties. In one embodiment, both the intensity function I(x, y) and its gradient G(x, y) is used to obtain a good speed function. According to this embodiment, the speed function could be defined as:
F(x,y)=1/(const·e^{I}^{_{S}}^{(x,y)}·e^{G}^{_{S}}^{(x,y)})
where I_{S}(x, y) is an intensity based function and G_{S}(x, y) is a gradient G(x, y) based function. For instance, in one embodiment, I_{S} (x, y) is the pixel by pixel accumulated intensity I(x, y) taken from the initial seed (pixel) and G_{S}(x, y) is the accumulated gradient (G(x, y)) from the initial seed. This means that the speed function, I_{S}(x, y) and G_{S}(x, y) are created in an iterative manner from each initial seed and summed outwards to the actual position (x, y).

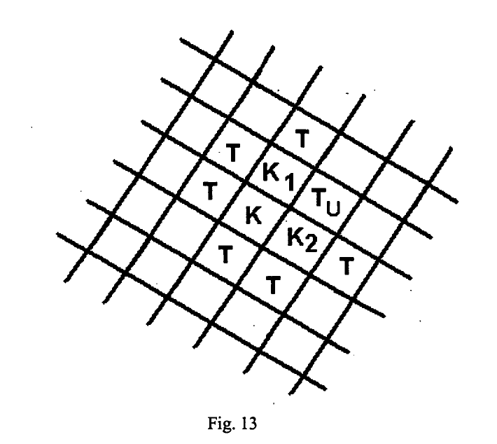

FIG. 13, illustrates a schematic view for the creation of I_{S} (x, y) and G_{S} (x, y). In FIG. 13, K denotes the initial seed pixel, K₁, K₂ denotes Known iterated values and, in contrast with the rest of this description, T denotes Trial values. Thus, the iteration illustrated in FIG. 13 starts by calculating the value of I_{S} (x, y) and G_{S}(x, y) in the initial seed pixel (Kx, Ky) by letting,
I_{S}(Kx,Ky)=I(Kx,Ky), and
G_{S}(Kx,Ky)=G(Kx,Ky).
Having the values of I_{S} and G_{S} defined in the initial seed I_{S} and G_{S} in its neighbours, e.g. K₁ and K₂, is obtained by simple addition:
I_{S}(K₁x,K₁y)=I(Kx,Ky)+I(K₁x,K₁y), and
G_{S}(K₂x,K₂y)=G(Kx,Ky)+G(K₂x,K₂y).
In this way, I_{S} and G_{S} for all neighbour pixels of the initial seed pixel can be obtained. The iteration then proceeds to the next series of pixels by combining the previously obtained values. For instance, the speed in T_{U} in FIG. 13 is given by:

$$F ( {T}_{U} ) = \frac{1}{α * {ⅇ}^{{I}_{S} ( {T}_{U} )} * {ⅇ}^{{G}_{S} ( {T}_{U} )}}$$

where α is a constant,
I_{S}(T_{U})=(I_{S}(K)+I_{S}(K₁)+I_{S}(K₂))/3+I(T_{U})
G_{S}(T_{U})=(G_{S}(K)+G_{S}(K₁)+G_{S}(K₂))/3+G(T_{U})
The idea is that for each step outward from the initial seed position, the value is given as a summation of the mean values from the accepted neighbours to that point. The following algorithm summarises the calculation of I_{S} (x, y):
1. Get point (x, y) for which to calculate I_{S} (x, y): This is simply the position in which the speed is to be calculated.
2. Find previous values: Identify all 8 neighbours to the point (x, y) that are Known and have the same initial seed identification, and take the mean of them.
3. Add previous values with current: Take the mean value from step 2 and add it with the value in (x, y).
4. Store new value: Store and return the value to the surrounding.

In one embodiment the way the interface propagation is performed, according to the invention, the interface propagation will automatically block two different initial seed regions from overlapping. This holds because a Known value may never be turned into a Trial value, in the case when the speed function F(x, y) is strictly positive, according to the invention. One other way to guarantee that the segmentation of different spots will not overlap is to introduce a criterion regarding above Trial values in FIG. 13. For instance, Trial pixels already chosen that originate from another initial seed can be set to “not-allowed”, which will make it impossible for the interface to expand in that direction. This holds when the speed function F(x,y) is not restricted to only positive values. Yet, another way to block two interfaces from two different initial seed regions to overlap is to introduce a criterion regarding above Known values. The Known value may be processed only if it has the same initial seed identification as the current processed value. A person skilled in the art, and in particular in the field of Fast Marching methods and Level Set Methods, realises that above algorithm can be modified in many ways.

To improve the properties of the speed function even further, the gradient image G(x, y), on which Gₛ(x, y) is based, can be modified, according to the invention. Imagine a very small protein spot. The gradient of the spot is not very high, even at the borders. Around the spot there is only a homogenous background with hardly any gradient at all. To acquire a good speed function in such situations, the gradient image can be multiplied with a factor to raise the gradient in the background regions.

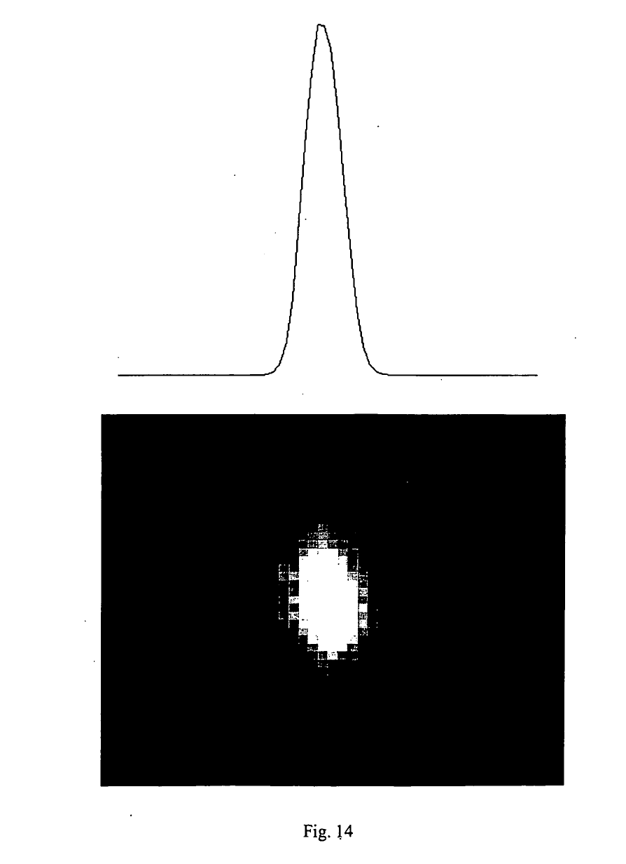

FIG. 14 shows one speed function (log-scaled) according to the invention obtained from the protein spot shown in FIG. 11. As can be seen, the speed function in FIG. 14 fulfils the above desired properties.

Above described speed function F(x, y) can be modified in many ways. Generally speaking, the speed function according to the invention can be based on:

Local Properties (L). These properties are controlled by the local information. They are, for example, normal vector and curvature.

Global Properties (G). Global properties depend on the shape and position of the entire interface front. For example, the speed also depends on associated differential equations associated with the entire interface.

Independent Properties (I). These are boundary shape independent and are decided by the underlying structure, in which the boundary is propagating. One example is a constant gradient that detects the movement of the interface.

The above described speed function depend on the pixel intensity, and/or functions thereof, and does not depend on the shape of the interface itself. It is therefore a speed function depending on boundary shape independent properties, according above. One possibility to improve the speed function even further, according to another embodiment of the invention, is to let the speed function in a pixel (x, y) also depend on global and/or local properties of the interface such as the angle between the intensity gradient, \overline{G}, in (x, y) and a vector \overline{V} starting at the initial seed and extending out to the pixel (x, y). Also, the instantaneous distance, |\overline{V}| to the initial seed can be used. An alternative speed function according to this embodiment can be:
F(x,y)=Const*G(x,y)²*I(x,y)/(αΔI(x,y)*\sqrt{|\overline{V}|})
Where α is the angle between \overline{V} and \overline{G}.

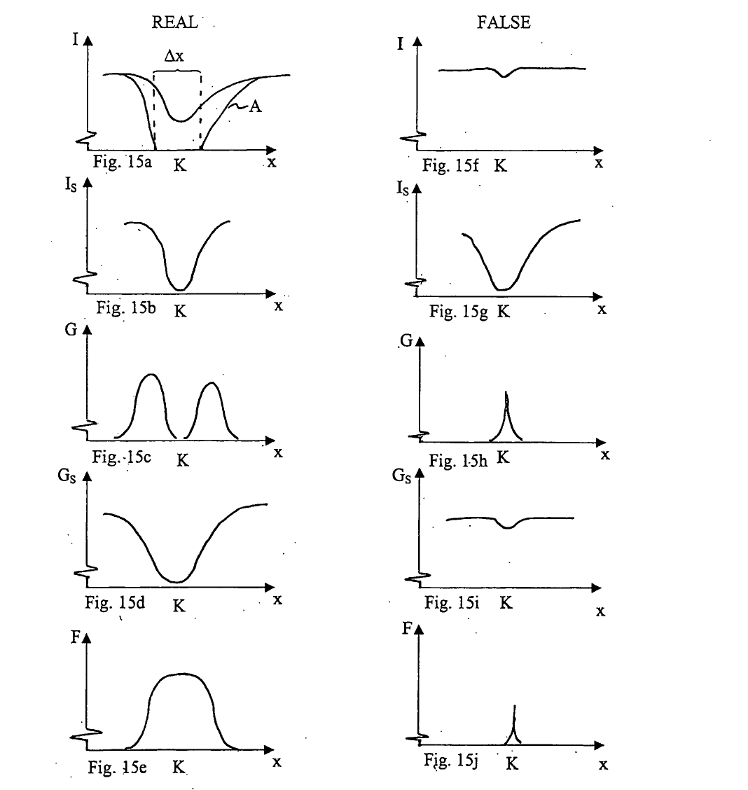

In case for the above speed function F(x, y), one embodiment according to the invention introduce a protected zone in the immediate surrounding of K, as indicated by ΔX in FIG. 15a in order to obtain a better performance of the speed function for saturated protein spots and/or disturbed protein spots. The intensity function for a typical saturated protein spot is indicated by graph A in FIG. 15a. Inside the protected zone, the speed function could e.g. be set to
F=Constant/|\overline{V}|
A saturated spot can be identified as a region with a mean intensity below a certain saturation threshold value, as described above. In this way, saturated or disturbed spots are given a speed function with the desired properties.

In yet another embodiment of the invention different speed functions, e.g. F₁(x, y), F₂(x, y), F₃(x, y) etc, is chosen based on the properties of the examined pixel (x, y). The following algorithm summarises the selection of different speed functions.

1. Get the pixel (x,y) for which to calculate the speed function: This is simply the Trial value, according to above, with the lowest T value.

2. Look at the properties of the examined pixel: This can be, e.g., but not limiting to, distance to the pixels corresponding initial seed, angle between the distance vector \overline{V} and gradient vector \overline{G}, the length of the gradient vector \overline{G}, the intensity and the intensity difference between the intensity in the pixel and its corresponding initial seed.

3. Depending on the properties of the pixel, chose a speed function among the different defined speed functions F₁(x, y), F₂(x, y), F₃(x, y) etc.

4. Calculate the speed for the pixel in accordance with the selected speed function.

In another embodiment of the present invention, the speed function depends on the curvature k of the expanding interface and/or functions thereof. The curvature k is in one embodiment of the invention defined as:
k=1/n#(M(x,+Δxᵢ,y+Δyᵢ)<0)−½, i=1, . . . ,n
where # is the number of elements and M(x,y) is defined as

$$M ( x , y ) = \{ \begin{matrix}1 & if & ( x , y ) is {}_{}^{′′}{Far}{}_{}^{′′} \\ - 1 & if & ( x , y ) is {}_{}^{′′}{Known}{}_{}^{′′} \\ 0 & if & ( x , y ) is {}_{}^{′′}{Trial}{}_{}^{′′}\end{matrix}$$

and where Δxᵢ is defined as

$$Δ {x}_{i} = round ( r * cos \frac{2 π i}{n} )$$

$$and$$

$$Δ {y}_{i} = round ( r * sin \frac{2 π i}{n} )$$

where r is a constant defining the radius of the curvature dependence.

In yet another embodiment, the speed function according to the invention depends on the curvature and/or shape of the intensity levels in the image and/or functions thereof. An example of such a speed function could be:

$$F ( x , y ) = \{ \begin{matrix}L ( x , y ) * I ( x , y ) / \vert \overline{V} \vert & if L ( x , y ) > 0 \\ I ( x , y ) / ( \vert L ( x , y ) \vert * \vert \overline{V} \vert ) & if L ( x , y ) <= 0\end{matrix}$$

In yet another embodiment, the speed function according to the invention depends on the normal direction of the expanding interface and/or functions thereof. Here an example of the definition of the normal direction id given by

$$\overline{N} = {\overline{N}}_{0} \frac{{N}_{0}}{\vert {N}_{0} \vert}$$

where
\overline{N}₀=(M(x+1,y)−M(x−1,y),M(x,y+1)−M(x,y−1))
where M(x, y) is defined as above.

In still another embodiment, the speed function according to the invention depend on the positions of the expanding interface and/or functions thereof.

In still another embodiment, the speed function according to the invention depends on the shape of the expanding interface and/or functions thereof.

Generally speaking, the speed function F(x, y) according to the invention can be written as:
F(x,y)=Local(x,y)*(1+a*k)+b*(scalar product of N and grad(abs(Local(x,y))))
where Local(x, y) is the local speed depending on the position of the interface, e.g. the inverse of the gradient of the intensity function, k is the local curvature, N is the normal vector of the interface and a and b are constants.

After the definition of a good speed function, the segmentation step 140 in FIG. 2 associates each initial seed obtained from step 135 with an interface circumscribing said seeds in the immediate surrounding of the seed. This means that the interface will evolve in all outward directions from the initial seed according to the defined speed function F(x,y). Thus, the interface will move relatively fast in directions having a high speed function value and relatively low in directions with a low speed function value. The interface evolution will continue until a certain stopping criterion is fulfilled, according to the invention.

The goal is that the interface of valid initial seeds, i.e. seeds inside protein spots, shall be expanded so as to circumscribe the area containing only the protein type in question, while the interface of false initial seeds, i.e. initial seeds outside protein spots, should be expanded as little as possible. Such a segmentation result will drastically facilitate later analysis of the 2D gel image both in case of manual and automatic analysis. For instance, an automatic analysis could include volume calculations of the segments wherein the obtained volumes are compared with the volume of a normal spot, in order to make conclusions regarding a spot's genuineness. Also, the seed area in se can be compared with known areas for genuine spots in a similar manner.

Now, assume that the speed function F(x, y) is allowed to have both negative and positive values, in accordance with an alternative embodiment. In this embodiment, the interface can both shrink and expand. The speed function will typically depend on the local position of the interface, the local curvature of the interface and the normal gradient vector field of the interface. These properties have all been described above.

In this embodiment the interface evolution is solved with the initial value formulation described above. This equation can be solved with the help of the Level Set methods, known to the person skilled in the art. The solution may also be approximated with a modified Fast Marching method as described by Nilsson and Heyden.

In order to solve the initial value formulation with the modified Fast Marching method, two times, the arrival time Tₐ and the departure time T_{d} for each point in the zero level set have to be stored, as known to a person skilled in the art. The arrival time Tₐ represent the time when the interface arrived to the point in question. The departure time T_{d} represent the time when the interface will depart from the point in question. The departure time is calculated according to the following equation

$${T}_{d} = {T}_{a} + \frac{1}{max \{ \vert F \vert , ɛ \}}$$

where ε is a small number
Thus, the Modified Fast Marching Method to solve the initial value equation, can be summarised in the two-dimensional case, i.e. the case relevant for the invention, by the following algorithm:
1. Find the seed contour and initialize M as described above. Compute F(x,y) and T_{d} at the Trial points. The initial arrival time is zero. The departure time is computed according to above equation.
2. Build a min-heap data structure like in the Fast Marching algorithm. Briefly this means constructing a complete binary tree with the property that the departure time at any given node is less than or equal to the departure time of its children. For details regarding heap implementation and how to maintain the heap property, see above description.
3. The active point Pₘᵢₙ with the smallest departure time is at the root of the heap and this point is denoted P_{Td}. Delete this item and restore the heap property. If Fₚ is positive make Pₘᵢₙ “Known” and add all its “Far” neighbors to the Trial set. Now the mapping value at Mp has changed from 0 to −1. This means that the curvature values at the active points at any of the locations (xₚ−Δxᵢ,yₚ−Δyᵢ), i=1, . . . ,n must be adjusted. However, this is rapidly achieved by increasing the curvature k by 1/n at each point. Note that transferring the 4-connected neighbours of p from the Far to Trial set does not affect curvature values when defined according to the above equations.
Because of the way k was defined, we must proceed somewhat differently if Fₚ is negative. Start off by making p “Far”. In this case, updating the curvature values in the circular neighbourhood p is not necessary since Mₚ changes from 0 to 1. However, adding the 4-connected neighbours of p affects the curvatures in their separate circular neighbourhoods. Subsequently, the k values at the active points of the respective circular neighbourhood must be decreased by 1/n.
4. Recompute F and T_{d} at invalidated points. This includes not only the points whose k may have been affected but also—if a vector field is used—any point in a four-connected neighbourhood of a point whose set membership has changed. The heap property must be restored accordingly.
5. Loop from step 3 while stopping criteria are not reached.

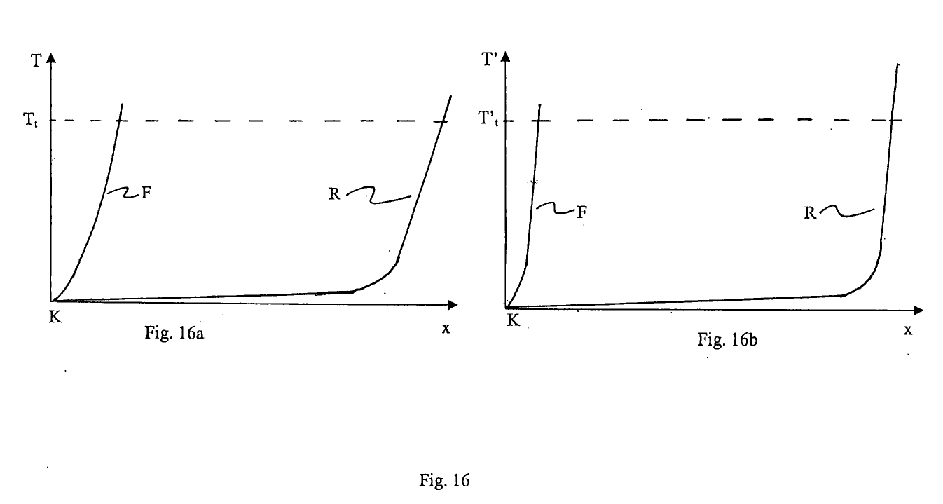

FIGS. 15 and 16 illustrates the segmentation technique according to the present invention. FIG. 15 shows illustrative examples for the intensity function I(x) in one dimension for a real spot to the left and a false spot to the right. K in FIG. 15 represents the initial seed pixel from which the interface is expanded. FIG. 15 illustrate the principal shape of I_{S}, G, G_{S} and F when obtained according to above described illustrative example. FIGS. 15a, 15b, 15c, 15d, 15e illustrate the case for a typical valid seed region and 15f, 15g, 15h, 15j, 15k illustrate the case of a typical false seed region.

As can be seen from FIG. 15e and 15k, the valid initial seed region will obtain a speed function F with high values in the surrounding area of K where a protein spot is present, while the false initial seed region will obtain a speed function with low values around K. Thus, the interface of the valid initial seed region will be expanded fast out to the protein spot border area while the false initial seed region will hardly be expanded at all.

The segmentation of the proteins, i.e. the propagation of the interface should stop when all of the protein spots have been isolated from each other and the background.

It is important to have good stopping criteria so that a robust and accurate segmentation is achieved. According to one embodiment of the present invention, the stopping criterion is based on the speed function F(x, y) so that the interface expansion will be stopped as soon as all the values of F are lower than a certain threshold.

According to another embodiment, the present invention provides a more efficient stopping criterion by using the calculated time of arrival, Tₐ(x, y), and/or functions thereof, of the expanding interface at the pixels (x, y). Tₐ(x, y) can easily be obtained in a given pixel since the interface expansion is solved by deriving the time function Tₐ(x, y) in each visited position by the interface. In one embodiment of the invention, a threshold value for the time of arrival Tₐ(x, y) is used as a stopping criterion, which is illustrated by the threshold value Tₜ in FIG. 16a.

In another embodiment, a threshold value for the gradient of the time of arrival Tₐ(x, y), i.e. T′ₐ, is used as a stopping criterion which is illustrated by threshold value T′ₜ in FIG. 16b.

FIGS. 15 and 16 are not to scale but illustrate merely the working principle of the invention.

In still another embodiment according to the invention, the accumulated time sum is used for creating a stopping criterion, not illustrated in FIG. 16.

Another possibility is that the stopping criterion depends on the departure time T_{d} for said interface.

In still another embodiment according to the invention, a combination of above stopping criteria can be used for the creation of a stopping criterion.

As illustrated by FIGS. 15 and 16, the speed of the evolving interface will decrease sharply and the time between each evolving step will increase when the protein spots have been isolated This is why the time gradient T′ will grow enormously at this stage and therefore suites very well as a stopping criterion. The total consumed time will also increase rapidly and works also very well as second stopping criterion. A combination of above stopping criteria can give an even better criterion, as understood by a person skilled in the art.

In yet another embodiment of the present invention, the segmentation result obtained by the speed function and stopping criterion according to the Fast Marching method could be further improved by applying the above presented alternate evolving interface propagation solved with the Level Set Methods or the modified Fast Marching methods, which are known mathematical methods, for defining a second interface speed function to be applied after the stoppage of the Fast Marching method described above. The Level Set Method and the modified Fast Marching Method are more complex and require a higher processing capability and/or more computational time. However, the Level Set Method has a higher potential to give a more accurate final result. Therefore, it can advantageously be used after that the Fast Marking method has given a first result in order to further improve the accuracy of the segmentation.

In still another alternative embodiment, the Fast Marking method is not used but the whole segmentation step 140 in FIG. 2 is carried out by means of the Level Set Method or the modified Fast Marching Method.

The present invention is typically realised in form of a software program, which for instance can be distributed in form of program code elements stored on a computer readable medium. The software program can also reside on a network server allowing a shared access or be pre-installed in a system for 2D gel image analysis, typically comprising a computer.

Above described algorithms can be varied and modified in many ways, obvious to a person skilled in the art. For instance, the size of the Mean filter and Gauss filter used to remove noise in the images can be modified. The curvature each local minimum surrounding has to have, to be regarded as a valid initial seed, i.e. an initial seed inside a protein spot, i.e. Spot Curvature Threshold can also be changed. Furthermore, the Spot Search Space can be modified, i.e. the size of the surrounding to a local minimum, for which the curvature is calculated can be adapted to different conditions.

Also, the Background Filter Size can be varied, i.e. the size of the blocks used to divide the image. Each block generates a mean value to be used in the background modulating function. The larger the filter size, the more coarse background module. The above described removal of noise and background could be carried out in a reverse order, or could even be left out, and many other modifications of above algorithms are obvious for a person skilled in the art. For instance, noise removal can be carried out with the help of more sophisticated filters and a more sophisticated frequency analysis. For instance, the known Level Set Method could be used to remove noise while keeping the interesting contours intact. The background variation removal could be improved by investigating the intensity histogram in different parts of the image, in accordance with known methods. Also, the background modulation could use other more accurate interpolation methods, for example cubic splines. Also, different filters and also spot models could be used.

As already stated, the speed function could depend on curvature information and other properties so that the interface propagation could be curvature shape dependant. By allowing the speed values to be both positive and negative, as stated above, equilibrium segmentation could is possible. By doing so, the stopping criteria would be trivial, i.e. a specific criterion regarding the grade of equilibrium, e.g. less than a certain number of interfaces change less than a certain amount during a certain time period. The stoppage of the evolving interfaces could also be done after a predefined time.

By defining certain templates, i.e. predetermined shapes and/or contours for a typical genuine protein spot, even better results may be obtained. Typically, the software algorithm realising the present invention has an automatic parameter setting function controlling some or all of above parameters, which can be overridden manually in a preferred embodiment. Therefore, the scope of the invention is not restricted to the above examples but is only defined by the following claims.

1-21. (canceled)

22. A method for segmenting a 2D gel image by associating initial protein seed candidates with surrounding regions, comprising the steps of:
defining at least one interface circumscribing an initial seed in its immediate surrounding,
defining a velocity function F(x, y) for said interface,
bringing said interface to evolve in accordance with F(x, y),
defining at least one stopping criterion C and stopping the evolution of said interface in accordance with said criterion,
associating the area inside said stopped interface with said initial seed.

23. The method according to claim 22, comprising the steps of:
calculating the time of arrival, Tₐ(x, y) for said evolving interface in pixels surrounding said initial seed
defining said stopping criterion C so that C depends on Tₐ(x, y) in the pixel representing the latest circumscribed pixel by said evolving interface and/or functions thereof.

24. The method according to claim 23 wherein said stopping criterion C depends on the gradient Tₐ′ of Tₐ(x, y) in the pixel representing the latest circumscribed pixel by said evolving interface and/or functions thereof.

25. The method according to claim 22, wherein said stopping criterion C is defined so that C depends on F(x, y) and/or functions thereof.

26. The method according to claim 22, wherein the evolution of said interface is carried out by
defining and calculating a time of arrival, Tₐ(x, y), for a set of trial candidate pixels,
identifying the trial candidate pixel P_{Tmin} with the smallest Tₐ, and
letting the interface evolve to said trial candidate pixel P_{Tmin}.

27. The method according to claim 26, comprising the step of
rejecting a trial candidate pixel as a candidate pixel if it is established that said candidate trial pixel constitutes a pixel representing a known pixel associated with an evolving interface originating from another initial seed.

28. The method according to claim 22, wherein the evolution of said interface is carried out by:
an iterative calculation of Tₐ(x, y) for a set of candidate pixels,
defining and calculating a departure time, T_{d}, for said candidate pixels,
identifying the candidate pixel P_{Td} with the smallest T_{d},
letting the interface propagate to said pixel points, P_{Td}, outside or inside neighbours depending on the sign of the speed function F in said point P_{Td}.

29. The method according to claim 28, comprising the step of
rejecting a trial candidate pixel as a candidate pixel if it is established that said trial candidate pixel constitutes a pixel representing a known pixel associated with an evolving interface and that the value of the speed function F(x, y) in said trial candidate pixel is positive.

30. The method according to claim 22, comprising the following steps
defining a first function F₁(x, y),
defining at least a second function F₂(x, y) differing from F₁(x, y),
defining a criterion C2 for at least an amount of pixels inside a region of said image, wherein said criterion C2 defines weather F₁(x, y) or F₂(x, y) is valid for said amount of pixels.

31. The method according to claim 30, wherein said criterion C2 is a criterion for identifying saturated regions.

32. The method according to claim 22, wherein F(x, y) depends on the intensity function I(x, y) for said image and/or functions thereof.

33. The method according to claim 22, wherein F(x, y) depends on the distance to said initial seed and/or functions thereof.

34. The method according to claim 22, wherein F(x, y) depends on the curvature of said evolving interface and/or functions thereof.

35. The method according to claim 22, wherein F(x, y) depends on the normal direction of said evolving interface and/or functions thereof.

36. The method according to claim 22, wherein F(x, y) depends on the curvature of the intensity function I(x, y) and/or functions thereof.

37. The method according to claim 22, wherein F(x, y) depends on the gradient G(x, y) of the intensity function I(x, y) for said image and/or functions thereof.

38. The method according to claim 22, wherein F(x, y) depends on the shape of said evolving interface and/or functions thereof.

39. The method according to claim 22, wherein F(x, y) depends on the angle between the intensity gradient, \overline{G}, of I(x, y), and a vector \overline{V} representing the instantaneous distance to (x, y).

40. A computer program element to be used for the segmentation of a 2D gel image by associating initial protein seed candidates with surrounding regions, said program element comprising computer program code means making a computer execute the steps defined by any of above claims 22-39.

41. A computer readable medium, comprising computer program code means making a computer execute the steps defined by any of above claims 22-39.

42. A system for processing 2D gel images comprising a computer, wherein said computer has access to a program element computer to be used for the segmentation of a 2D gel image by associating initial protein seed candidates with surrounding regions, said program element comprising computer program code means making a computer execute the steps defined by any of above claims 22-39.
